(19) United States
(12) Patent Application Publication
(10) Pub. No.: US 2024/0150174 A1
(43) Pub. Date: May 9, 2024

(54) Systems, Methods and Apparatus for Manufacturing Helium-3 from a Beam of Protons

(71) Applicant: Kepler Fusion Inc., Midland, TX (US)

(72) Inventors: John Brandenburg, Midland, TX (US); Michael G. Smith, Keller, TX (US)

(21) Appl. No.: 17/974,516

(22) Filed: Oct. 26, 2022

(51) Int. Cl. C01B 23/00

(52) U.S. Cl. CPC C01B 23/00

(57) ABSTRACT

Systems, methods and apparatus are provided through which in some implementations helium-3 is manufactured by causing a p+6Li->3He+4He reaction or a p+²H→³He+γ reaction, the systems, methods and apparatus including a target; and a particle accelerator that forms a beam that is directed at the target, causing a collision between the beam of the protons and the target, the collision causing the p+6Li->3He+4He reaction or the p+²H→³He+γ reaction, producing helium-3 gas, the particle accelerator including a power source that is operably coupled to a proton gun that is operably coupled to a beam transport system.

### FIELD

This disclosure relates generally to producing nuclear reactor fuel, and more particularly to producing helium-3 nuclear fusion fuel.

### BACKGROUND

Conventional methods of manufacturing helium-3 are expensive and sometimes produce dangerous radioisotopes as by-products. In one example of manufacturing helium-3, tritium is allowed to radioactively decay over a long period of time, producing helium-3. But, production must be planned over a long period of time and requires long-term storage of the tritium. Helium-3 is used in neutron detection, cryogenics, lung nuclear magnetic resonance medical imaging, radio energy absorber for tokamak plasma experiments and as a nuclear fuel.

### BRIEF DESCRIPTION

The above-mentioned shortcomings, disadvantages and problems are addressed herein, which will be understood by reading and studying the following specification.

In one aspect, a system for manufacturing helium-3 includes a target; and a particle accelerator that forms a beam of protons at the target, causing a collision between the beam of protons and the target, the collision causing the p+6Li->3He+4He reaction, producing helium-3 gas and helium-4 gas, the particle accelerator including a power source that is operably coupled to a proton gun that is operably coupled to a beam transport system.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of a system for manufacturing helium-3, according to an implementation.

FIG. 2 is a diagram of reaction cross sections as a function of energy for p+6Li collisions, according to an implementation.

FIG. 3 is a block diagram of an apparatus for manufacturing helium-3 in which a particle accelerator forms a beam of protons in a range of 0.3 to 1 MeV at a target made of lithium-6, according to an implementation.

FIG. 4 is a block diagram of an apparatus for manufacturing helium-3 in which a particle accelerator forms a beam of lithium-6 at a target made of hydrogen, according to an implementation.

FIG. 5 is a block diagram of an apparatus for manufacturing helium-3 by causing a p+²H→³He+γ reaction in which a particle accelerator forms a beam of protons at a target made of deuterium, according to an implementation.

FIG. 6 is a diagram of reaction cross sections as a function of energy for p+²H→³He+γ reaction, according to an implementation.

FIG. 7 is a block diagram of an apparatus for manufacturing helium-3 in which a particle accelerator forms a beam of ²H at a target made of hydrogen, according to an implementation.

FIG. 8 is a flowchart of a method of manufacturing helium-3 by causing a p+6Li->3He+4He reaction, according to an implementation.

FIG. 9 is a flowchart of a method of manufacturing helium-3 in which a particle accelerator forms a beam of protons in a range of 0.3 to 1 MeV at a target made of lithium-6, according to an implementation.

FIG. 10 is a flowchart of a method of manufacturing helium-3 in which a particle accelerator forms a beam of lithium-6 at a target made of hydrogen, according to an implementation.

FIG. 11 is a flowchart of a method of manufacturing helium-3 by causing a p+²H→³He+γ, reaction, according to an implementation.

FIG. 12 is a flowchart of a method of manufacturing helium-3 in which a particle accelerator forms a beam of ²H at a target made of hydrogen, according to an implementation.

FIG. 13 is a block diagram of a helium-3 manufacturing control computer in which different implementations can be practiced.

FIG. 14 is a block diagram of a data acquisition circuit of the helium-3 manufacturing control computer, according to an implementation.

FIG. 15 is a block diagram of a hardware and operating environment in which different implementations can be practiced.

FIG. 16 is a block diagram of a helium-3 manufacturing control mobile device, according to an implementation.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into five sections. In the first section, a system level overview is described. In the second section, apparatus of implementations are described. In the third section, implementations of methods are described. In the fourth section, a hardware and the operating environment in conjunction with which implementations may be practiced are described. Finally, in the fifth section, a conclusion of the detailed description is provided.

### System Level Overview

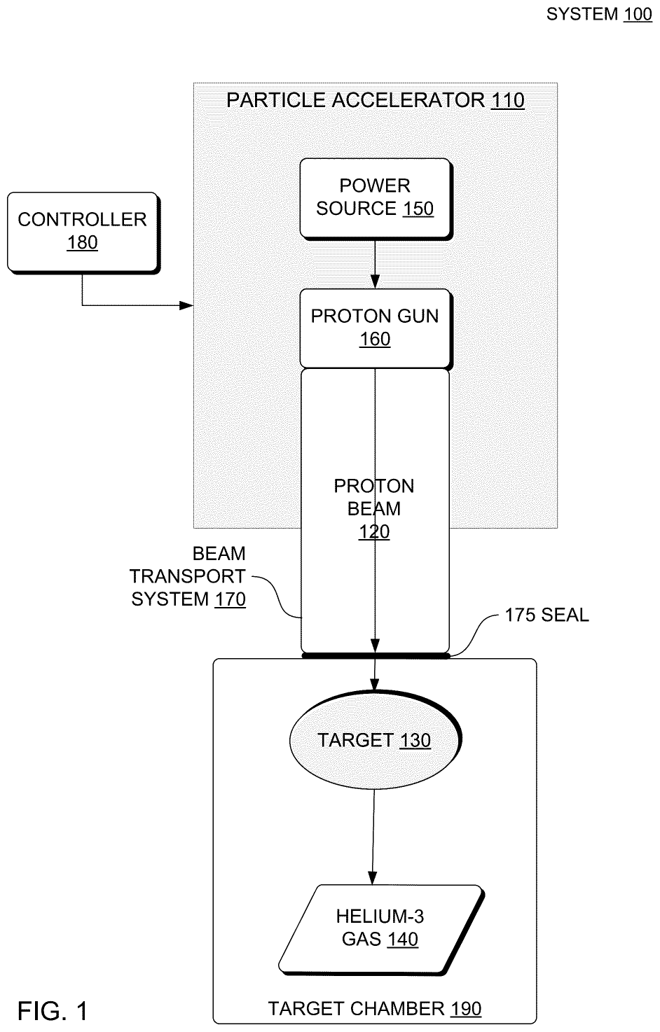

FIG. 1 is a block diagram of a system 100 for manufacturing helium-3, according to an implementation.

System 100 includes a particle accelerator 110 that forms a beam of protons 120 at a target 130, producing helium-3 gas 140. In some implementations, the particle accelerator 110 includes a power source 150 operably coupled to a proton gun 160 operably coupled to a beam transport system 170. In some implementations, the power source 150 includes a magnetron. In some implementations, the power source 150 includes a static electricity generator. In some implementations, the power source 150 includes a radio-frequency (RF) power source, such as a mega-hertz oscillator, to energize a linear accelerator. In some implementations, the beam transport system 170 includes a waveguide that is operably coupled to steering coils that are operably coupled to focusing coils.

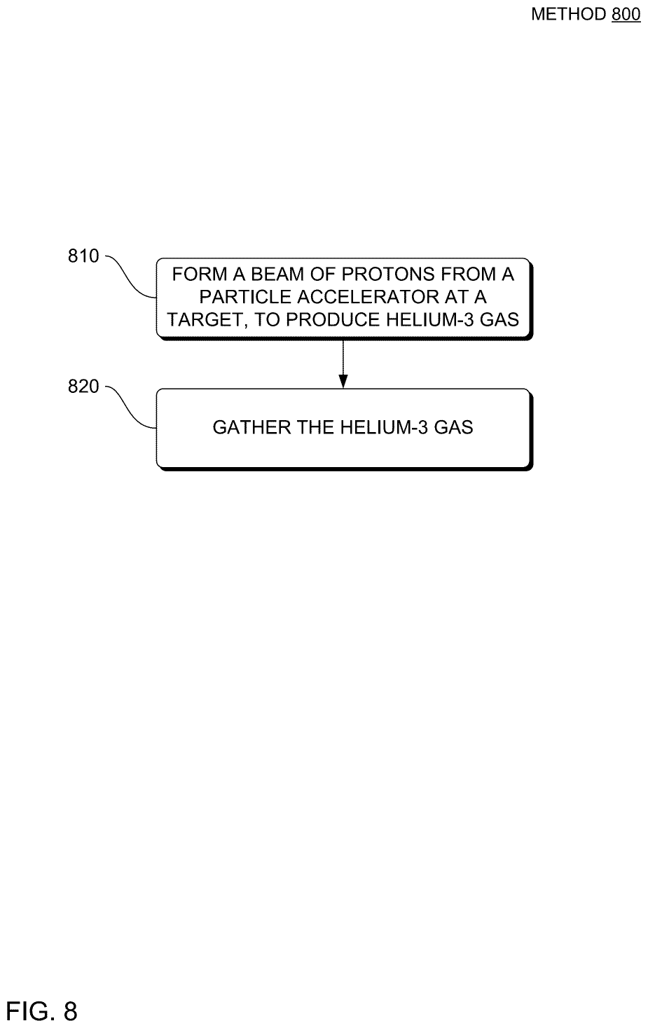

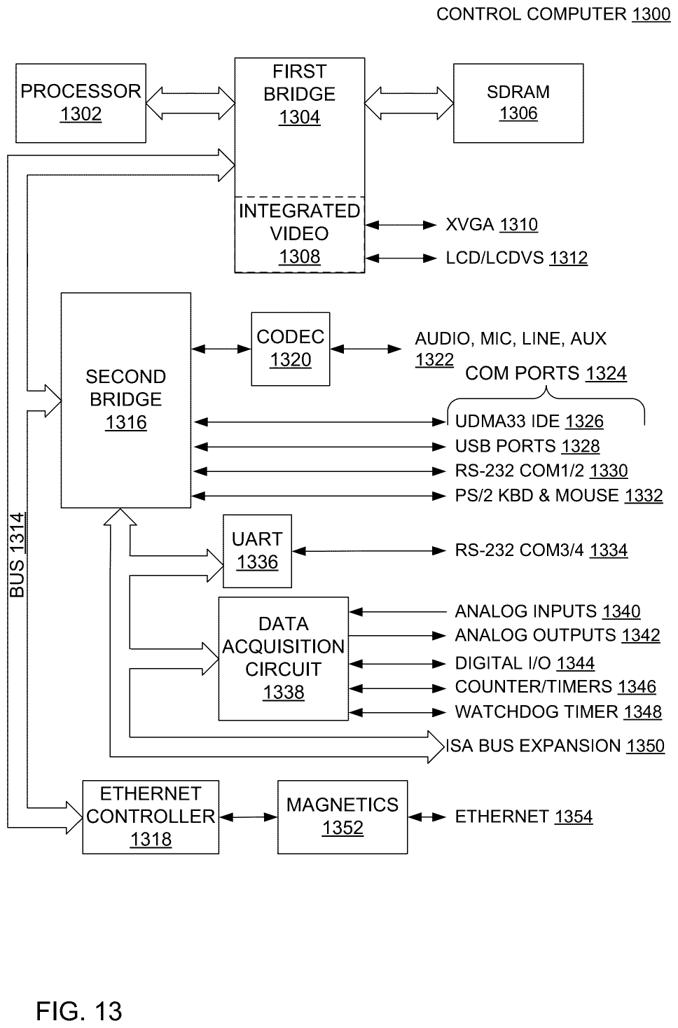

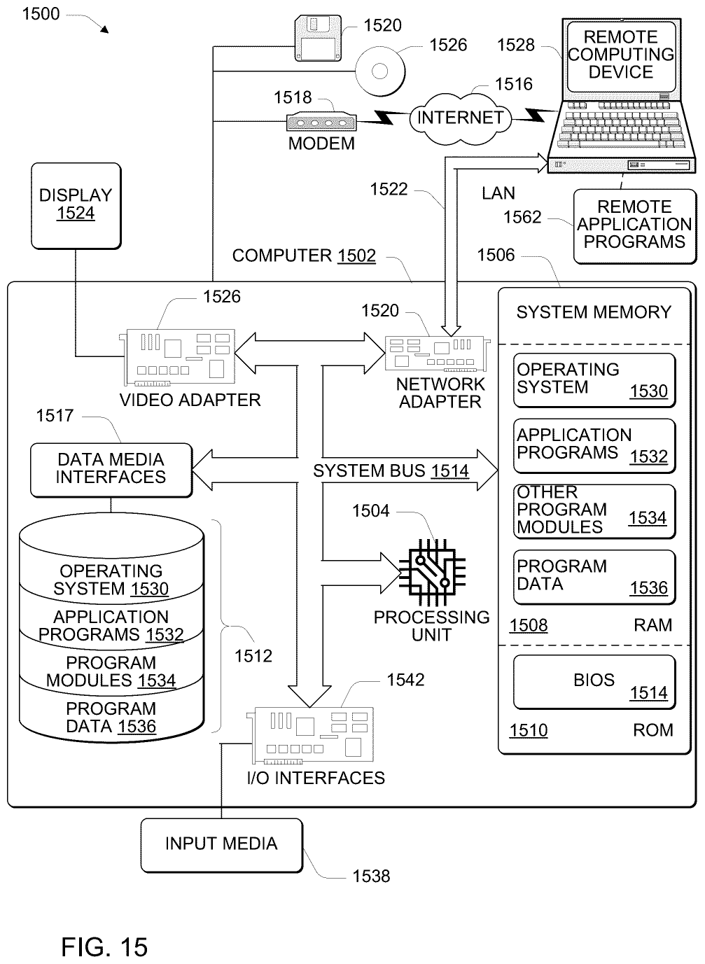

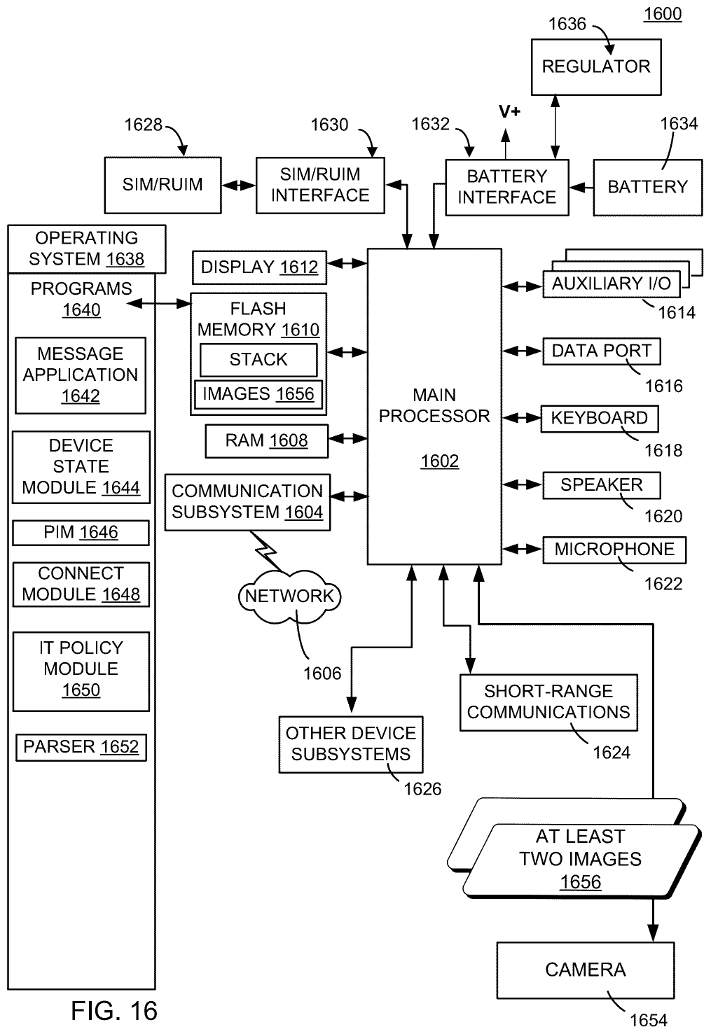

In some implementations, the target 130 includes high pressure gas. In some implementations, the target 130 is chemically combined with a substance forming a stable hydride, such as titanium, that will not react with the beam of protons 120. System 100 performs method 800 in FIG. 8. Method 800 in FIG. 8 is performed by the controller 180. The controller 180 can be internal or external to the particle accelerator 110. Examples of the controller 180 include the helium-3 manufacturing control computer in FIG. 13, a hardware and operating environment in FIG. 15 and a helium-3 manufacturing control mobile device in FIG. 16.

In some implementations of the beam transport system 170 in FIGS. 1, 3-5 and 7, the beam transport system 170 is a pipe that is sealed at both ends from which all or nearly all gas is vacuum pumped and which includes a seal 175 (that may be made of a thin metal) at an end that is adjacent to a target chamber 190 that contains the target (e.g. target 130). A beam, such as proton beam 120, travels from the gun (such as proton gun 160) through the beam transport system 170 to the target chamber 190. In some implementations, the target chamber 190 includes gaseous argon to slow down the helium-3 as it escapes the target to prevent the helium-3 from embedding in the interior wall of the target chamber 190.

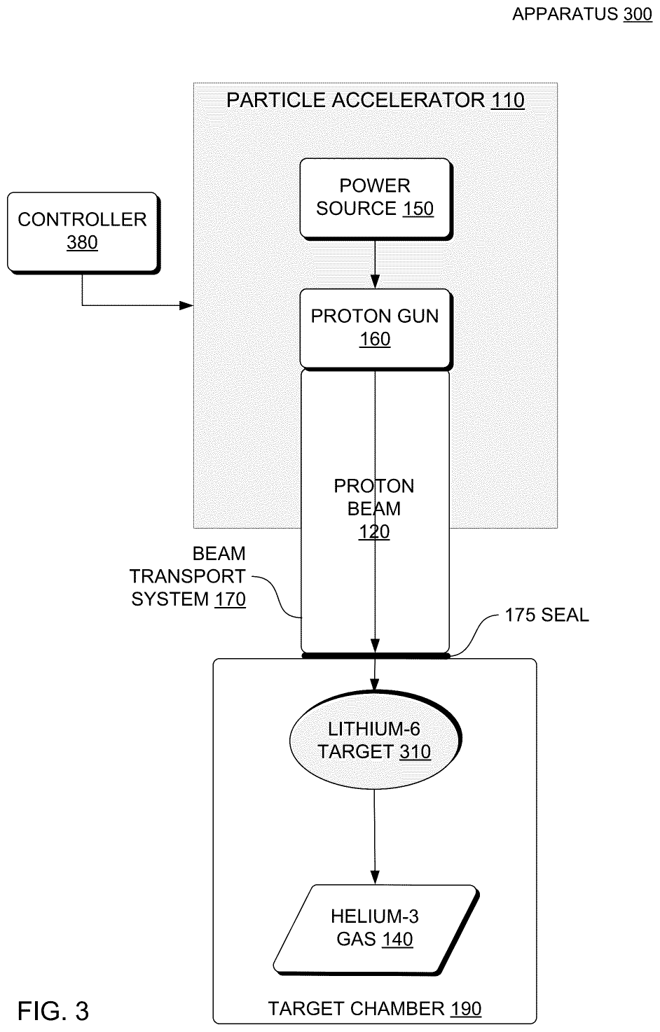

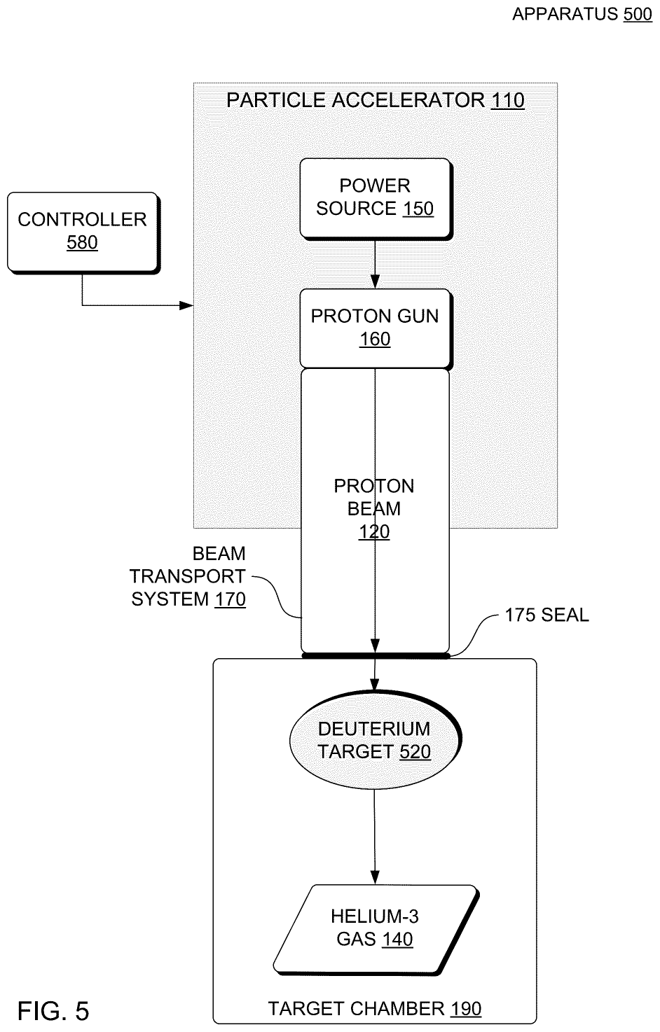

In some implementations, system 100, apparatus 300 and apparatus 500 include an energy recovery system consisting of a high efficiency thermal-energy-to-electrical-power-converter, such as a sterling engine, operably coupled to controller 180, 380 or 580, respectively, in order to recover most of the proton beam energy and nuclear reaction energy in order to make helium-3 at nearly zero energy cost. FIG. 1 is a high-level description of FIG. 3 and FIG. 5.

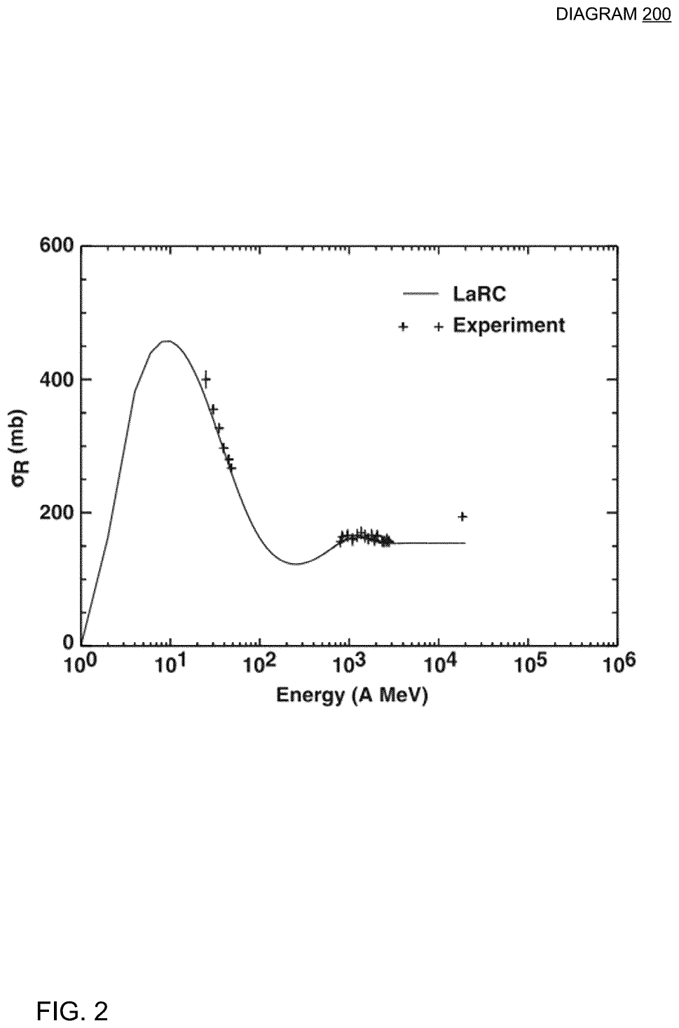

FIG. 2 is a diagram 200 of reaction cross sections as a function of energy for p+6Li collisions, according to an implementation. The diagram 200 shows reaction cross sections as a function of energy for p+6Li collisions of FIGS. 3-4, and 10-11.

### Apparatus Implementations

In the previous section, a system level overview of the operation of an implementation was described. In this section, the particular apparatus of such an implementation are described by reference to a series of diagrams.

FIG. 3 is a block diagram of an apparatus 300 for manufacturing helium-3 in which a particle accelerator forms a beam of protons at a target made of lithium-6, causing a p+6Li->3He+4He reaction, according to an implementation.

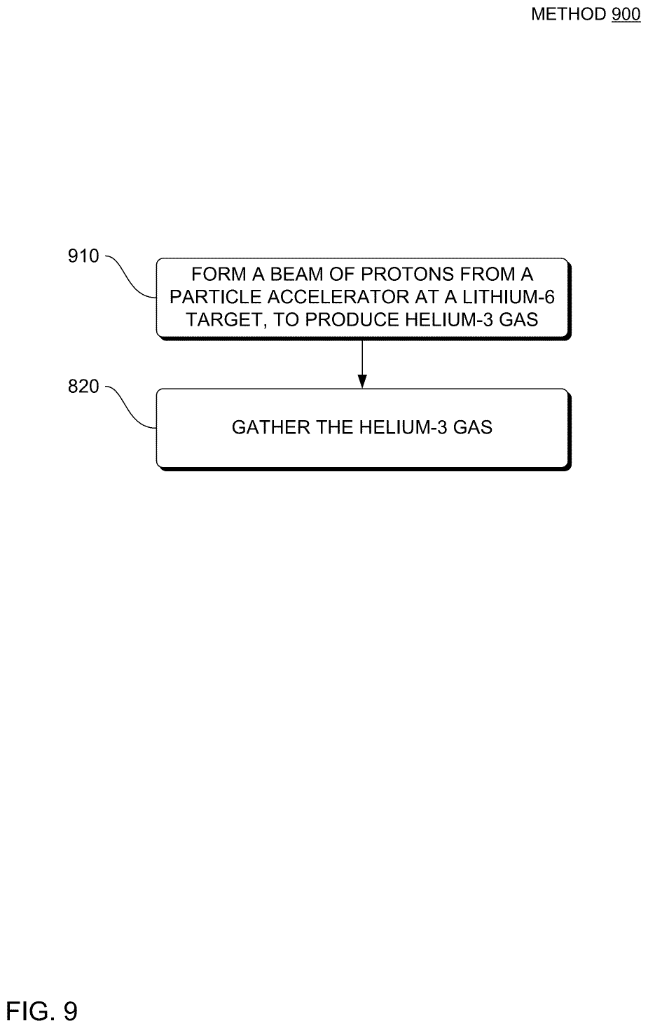

Apparatus 300 includes a particle accelerator 110 that forms a beam of protons 120 at a target 310 made of lithium-6, producing helium-3 gas 140 and helium-4 gas. In some implementations, energy level of the beam of protons 120 is in a range of 0.3 to 1 MeV. In some implementations, the particle accelerator 110 includes a power source 150 operably coupled to a proton gun 160 operably coupled to a beam transport system 170. In some implementations, the beam transport system 170 includes a waveguide that is operably coupled to steering coils that are operably coupled to focusing coils. The apparatus 300 causes a p+6Li->3He+4He reaction. In some implementations, the lithium-6 target 310 includes high pressure gas. In some implementations, the lithium-6 target 310 is chemically combined with a substance forming a stable hydride, such as titanium, that will not react with the beam of protons 120. In some implementations, the lithium-6 target 310 consists of thin alternating layers of solid or gaseous lithium-6 and quartz (quartz membranes pass Helium rapidly, but block other gases). Apparatus 300 performs method 900 in FIG. 9. Method 900 in FIG. 9 is performed by the controller 380. The controller 380 can be internal or external to the particle accelerator 110.

One expression of this reaction is p+₃⁶Li→₂³He+α+4.0 MeV⁻1 thus produces energy, allowing energy recovery in addition to helium-3 production. This reaction allows production of helium-3 without production of highly radioactive and dangerous tritium. This reaction will produce helium-3 with near-zero radioactive materials by side reactions. The raw materials for this reaction are merely ordinary hydrogen and Lithium-6 (7.5% of natural lithium, both non-radioactive). Lithium-6 is easily separated from lithium-7, its more abundant cousin. FIG. 3 is one implementation of FIG. 1.

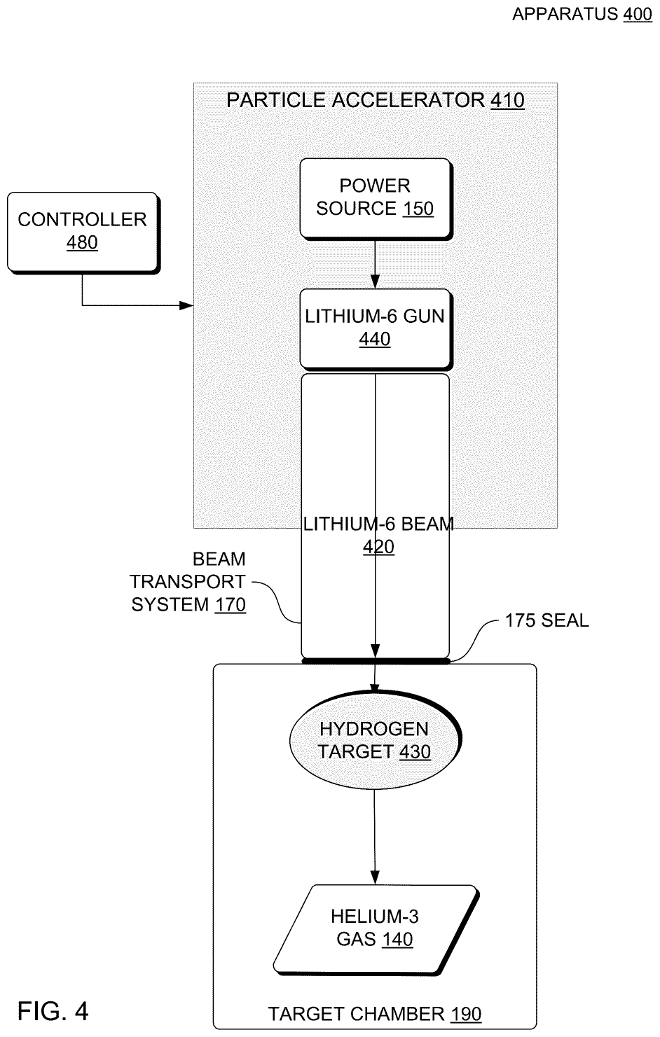

FIG. 4 is a block diagram of an apparatus 400 for manufacturing helium-3 in which a particle accelerator forms a beam of lithium-6 at a target made of hydrogen, according to an implementation.

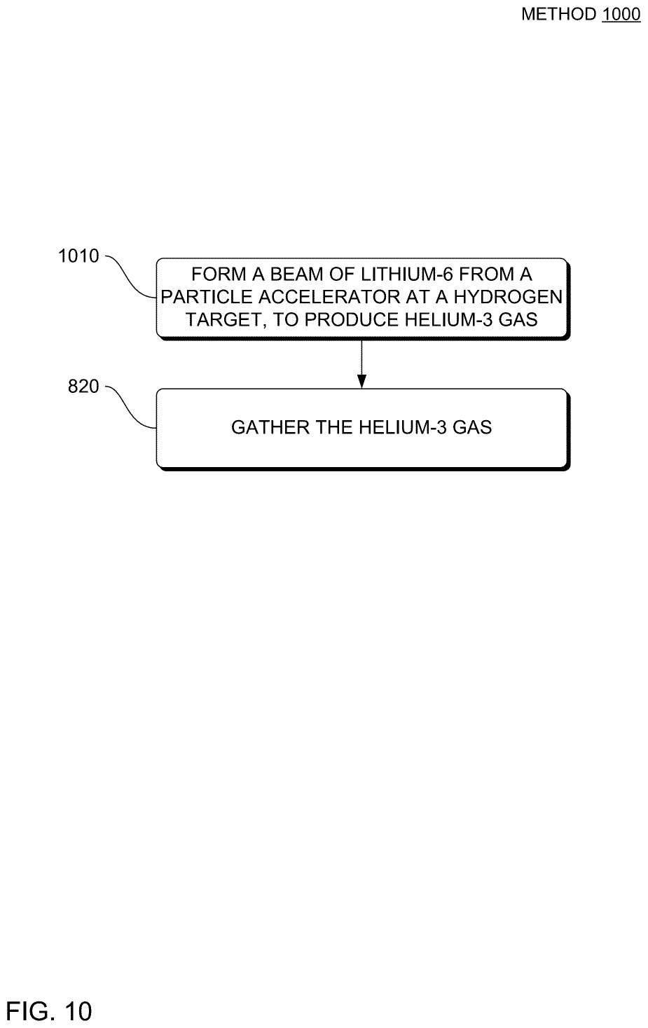

Apparatus 400 includes a particle accelerator 410 that forms a beam of lithium-6 420 at a target 430 made of hydrogen, producing helium-3 gas 140 and helium-4 gas. In some implementations, the particle accelerator 410 includes a power source 150 operably coupled to a lithium-6 gun 440 operably coupled to a beam transport system 170. In some implementations, the beam transport system 170 includes a waveguide that is operably coupled to steering coils that are operably coupled to focusing coils. The apparatus 400 causes a p+6Li->3He+4He reaction. In some implementations, the lithium-6 target 310 includes high pressure gas. In some implementations, the hydrogen target 430 is chemically combined with a substance forming a stable hydride, such as titanium, that will not react with the lithium-6 beam 420. Apparatus 400 performs method 1000 in FIG. 10. Method 1000 in FIG. 10 is performed by the controller 480. The controller 480 can be internal or external to the particle accelerator 410.

To make beams of lithium particles 420, the particle gun include a surface ionizer is used to⁻⁺store the polarized lithium particles, because on one hand a surface ionizer conserves the polarization to at least 80%, and on the other hand the desorption time is some 10 to 100 ms. The particle gun 440 also includes a polarization analyzer chosen the reaction lithium-6 at 425 keV proton energy. The reaction cross section for lithium-6 has already has been measured very accurately from 400 keV to 960 keV mean proton energies. Under the assumption of pure S-wave contribution one can conclude that the tensor analyzing powers of these reactions are equal. The assumption of pure S-wave contribution can be expected to be correct considering the low energy and the fact that P-waves cannot contribute because of the two α-particles in the exit channel. A linear interpolation of the reaction cross section at 400 and 600 keV can be made to get the values at 425 keV.

In some implementations, the particle accelerator 410 includes a lithium oven, a 6-pole magnet, a strong-field transition (250 MH), a weak-field transition, a shutter, a target drive, a detector, an electromagnet, a secondary electron suppression, a thin surface ionizer, a collimator, an analyzing 6-pole magnet, a thin surface ionizer and a pyrometer. The polarized atomic lithium-6 is made by separation of the hyperfine components in a tapered permanent sextuple magnet. The particle flow behind the sextuple has been equivalent to 5 μA, which can easily be augmented to 20 μA. Nuclear polarization in a strong magnetic field is obtained by applying strong and weak field transitions by adiabatic passage. The efficiencies of these transitions have been frequently analyzed by a second sextuple. For these measurements the thin surface ionizer can be driven out of the lithium beam 420. The thin surface ionizer includes a 50 μm thick tungsten tape being 10 mm width and 50 mm height. The thin surface ionizer is directly heated to about 1300° C.-1400° C. by alternating current and additionally by the 20 μA electron beam from a Van de Graaff accelerator. The temperature of the thin ionizer is controlled by a pyrometer. An oxygen leak provides a monolayer of oxygen on the tungsten so that the efficiency of the thin ionizer is nearly 100%. A strong electromagnet (50 mT) is installed in the thin ionization region to get high polarization values, to avoid depolarization effects and to define the direction of polarization. A voltage of 200 V provides that the lithium ions reach the catcher. The deuteron beam collimated to 7 mm diameter enters the target chamber at an angle of 11° to the tungsten tape which itself is inclined to the lithium beam axis with an angle of 45°.

In some implementations, the energizing α-particles are detected by two surface-barrier counters, shielded by 12 μm aluminum foils, which are placed at the angles w₁=0°; ₁=104.9°; 13₁=0° and w₂=59°; 2=84.9°; /32=59°.

The anisotropy of the emerging α-particles from the lithium-6 (d, α) a reaction is defined as n=Z₁(pol.) Z₂(unpol.)/Z₁(unpol.)Z₂(pol.) where the Z₁ are the counting rates. Under the assumptions Pz=−⅓P [symbol] for the hyperfine-transition 3-5 and P [symbol] =+l/3P [symbol] for 2-6 we have got the maximum target tensor polarizations Pzz=0.81±0.06 (2-6) and P [symbol] =−0.73±0.11 (3-5) for the anisotropies n=1.27. The main deviations of these values from ±1 are originated by incomplete hyperfine transitions.

FIG. 5 is a block diagram of an apparatus 500 for manufacturing helium-3 by causing a p+²H→³He+γ reaction in which a particle accelerator forms a beam of protons at a target made of deuterium, according to an implementation.

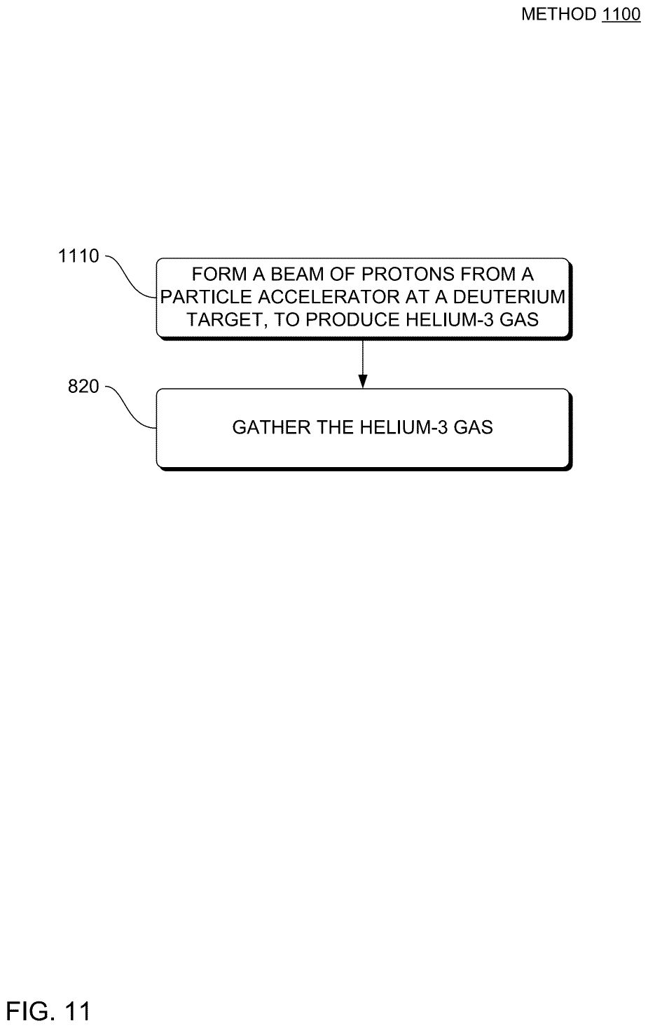

Apparatus 500 includes a particle accelerator 110 forms a beam of protons 120 at a deuterium target 520, causing a p+²H→³He+γ reaction, thus producing helium-3 gas 140. In some implementations, the particle accelerator 110 includes a power source 150 operably coupled to a proton gun 160 operably coupled to a beam transport system 170. In some implementations, the beam transport system 170 includes a waveguide that is operably coupled to steering coils that are operably coupled to focusing coils. In some implementations, the deuterium target 520 includes high pressure gas. In some implementations, the deuterium target 520 is chemically combined with a substance forming a stable hydride, such as titanium, that will not react with the beam of protons 120. Apparatus 500 performs method 1100 in FIG. 11. Method 1100 in FIG. 11 is performed by the controller 580. The controller 580 can be internal or external to the particle accelerator 110.

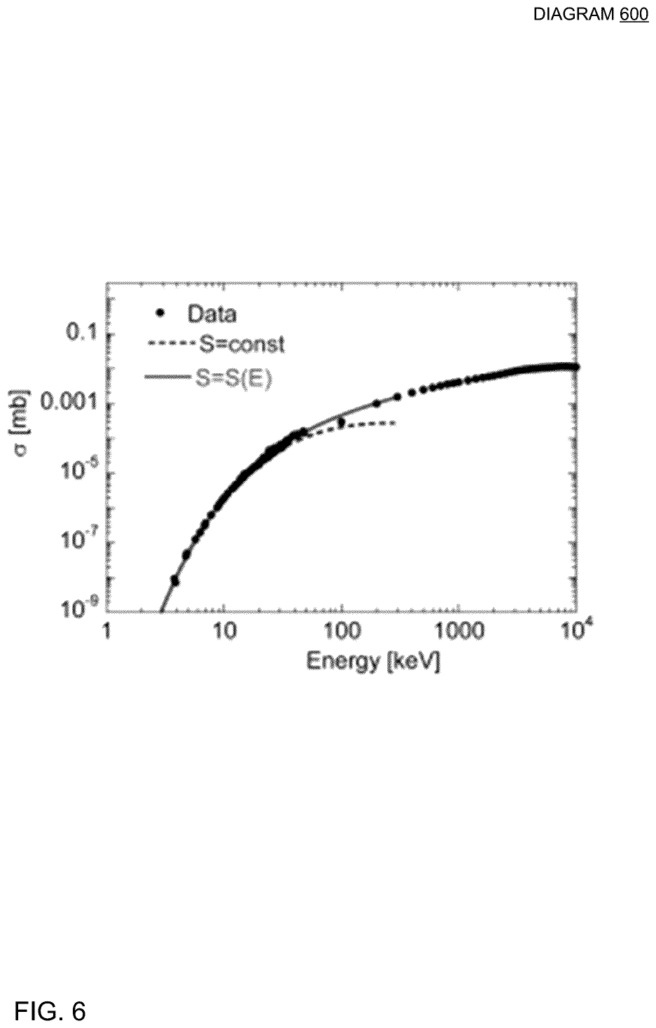

FIG. 6 is a diagram 600 of reaction cross sections as a function of energy for p+²H→³He+γ reaction, according to an implementation.

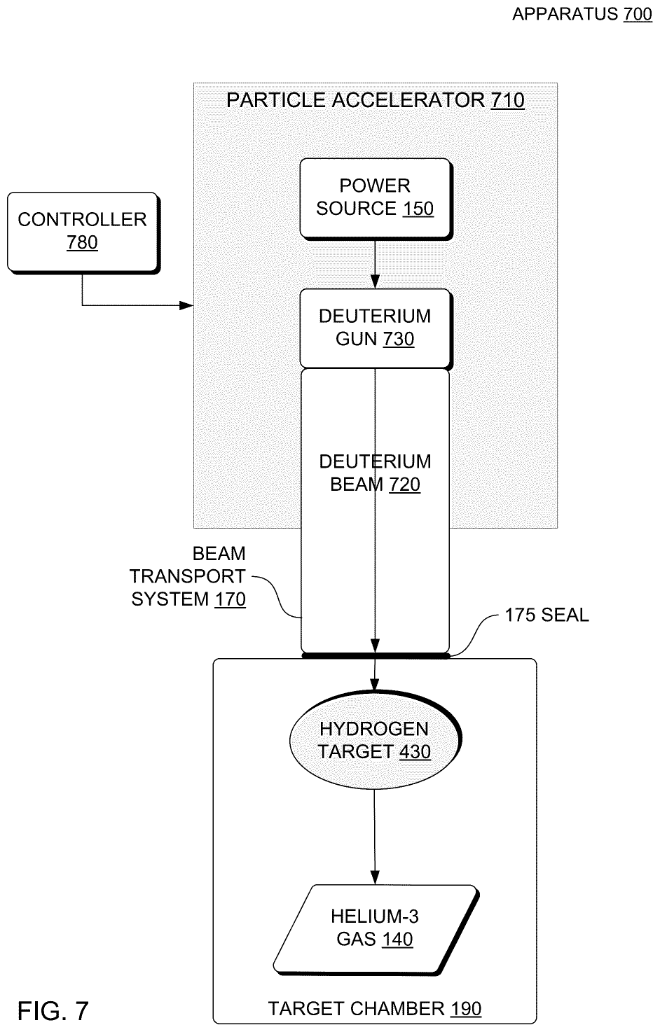

FIG. 7 is a block diagram of an apparatus 700 for manufacturing helium-3 in which a particle accelerator forms a beam of ²H at a target made of hydrogen, according to an implementation.

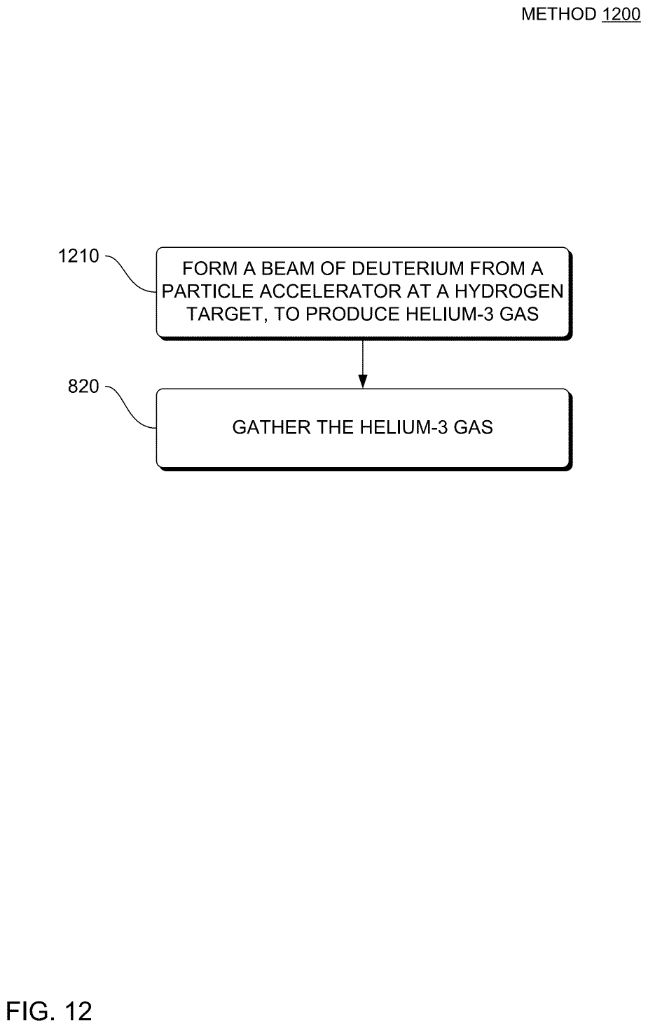

Apparatus 700 includes a particle accelerator 710 that forms a beam of deuterium 720 at a hydrogen target 430, producing helium-3 gas 140 and a gamma ray. In some implementations, the particle accelerator 710 includes a power source 150 operably coupled to a deuterium gun 730 operably coupled to a beam transport system 170. In some implementations, the beam transport system 170 includes a waveguide that is operably coupled to steering coils that are operably coupled to focusing coils. In some implementations, the hydrogen target 430 includes high pressure gas. In some implementations, the hydrogen target 430 is chemically combined with a substance forming a stable hydride, such as titanium, that will not react with the beam of deuterium 720. Apparatus 700 performs method 1200 in FIG. 12. Method 1200 in FIG. 12 is performed by the controller 780. The controller 780 can be internal or external to the particle accelerator 710.

### Method Implementations

In the previous section, apparatus of the operation of an implementation was described. In this section, the particular methods performed by controller 180 in FIG. 1, FIG. 3-5 and FIG. 7 of such an implementation are described by reference to a series of flowcharts.

FIG. 8 is a flowchart of a method 800 of manufacturing helium-3, according to an implementation.

Method 800 includes forming 810 a beam of protons 120 from a particle accelerator 110 at a target 130, producing helium-3 gas 140, and then gathering 820 the helium-3 gas 140. Method 800 is performed by system 100 in FIG. 1.

FIG. 9 is a flowchart of a method 900 of manufacturing helium-3 in which a particle accelerator forms a beam of protons in a range of 0.3 to 1 MeV at a target made of lithium-6, causing a p+6Li->3He+4He reaction, according to an implementation.

Method 900 includes forming 910 a beam of protons 120 from a particle accelerator 110 at a lithium-6 target 310, producing helium-3 gas 140 and helium-4 gas, and then gathering 820 the helium-3 gas 140. The method 900 causes a p+6Li->3He+4He reaction. Method 900 is performed by apparatus 300 in FIG. 3.

FIG. 10 is a flowchart of a method 1000 of manufacturing helium-3 in which a particle accelerator forms a beam of lithium-6 at a target made of hydrogen, according to an implementation.

Method 1000 includes forming 1010 a beam of lithium-6 420 from a particle accelerator 110 at a hydrogen target 430, producing helium-3 gas 140 and helium-4 gas, and then gathering 820 the helium-3 gas 140. The method 1000 causes a p+6Li->3He+4He reaction. Method 1000 is performed by apparatus 400 in FIG. 4.

FIG. 11 is a flowchart of a method 1100 of manufacturing helium-3 by causing a p+²H→³He+γ, reaction, according to an implementation.

Method 1100 includes forming 1110 a beam of protons 120 from a particle accelerator 110 at a deuterium target 520, producing helium-3 gas 140, and then gathering 820 the helium-3 gas 140. The method 1100 causes a p+²H→³He+γ reaction. Method 1100 is performed by apparatus 500 in FIG. 5.

FIG. 12 is a flowchart of a method 1200 of manufacturing helium-3 in which a particle accelerator forms a beam of ²H at a target made of hydrogen, according to an implementation.

Method 1200 includes forming 1210 a beam of deuterium 720 from a particle accelerator 710 at a hydrogen target 430, producing helium-3 gas 140, and then gathering 820 the helium-3 gas 140. The method 1200 causes a p+²H→³He+γ reaction. Method 1200 is performed by apparatus 700 in FIG. 7.

In some implementations, methods 800-1200 are implemented as a sequence of computer instructions which, when executed by a processor, such as processor 1302 in FIG. 13, processing unit 1504 in FIG. 15 or main processor 1602 in FIG. 1602, cause the processor to perform the respective method. In other implementations, methods 800-1200 are implemented as a computer-accessible medium having executable instructions capable of directing a processor, such as processor 1302 in FIG. 13, to perform the respective method. In varying implementations, the medium is a magnetic medium, an electronic medium, or an optical medium.

In some implementations, gathering 820 the helium-3 gas includes passing or forcing a mixture of helium-3 and argon gas through a quartz membrane, in which the membrane captures the argon gas. In some implementations, gathering 820 the helium-3 gas includes separating the helium-3 gas from the helium-4 gas by forcing or passing the mixture of helium-3 gas and the helium-4 gas through or into magnetite or another magnetic powder, which captures the helium-3 gas (because helium-3 is magnetic), and then heating the helium-3-embedded-magnetite, which releases the helium-3.

### Hardware and Operating Environments

FIG. 13 is a block diagram of a helium-3 manufacturing control computer 1300 in which different implementations can be practiced. The helium-3 manufacturing control computer 1300 includes a processor 1302 (such as a Pentium III processor from Intel Corp. in this example) which includes dynamic and static ram and non-volatile program read-only-memory (not shown), a first bridge 1304, operating memory 1306 (SDRAM in this example). The first bridge 1304 includes integrated video 1308 that couples the helium-3 manufacturing control computer 1300 to a XVGA communication path 1310 and a LCD and/or LCDVS device 1312.

The first bridge 1304 is operably coupled to a bus 1314 and the bus 1314 is operably coupled to a second bridge 1316 and an Ethernet® controller 1318.

The second bridge 1316 is operably coupled to a CODEC 1320 and the CODEC 1320 is coupled to an audio port 1322. The second bridge 1316 is operably coupled to communication ports 1324 (e.g., UDMA IDE 1326, USB port(s) 1328, RS-232 1330 COM1/2 and/or keyboard interface 1332).

An RS-232 port 1334 is coupled through a universal asynchronous receiver/transmitter (UART) 1336 to the second bridge 1316.

The second bridge 1316 is operably coupled to a data acquisition circuit 1338 with analog inputs 1340 and outputs 1342 and digital inputs and outputs 1344.

In some implementations of the helium-3 manufacturing control computer 1300, the data acquisition circuit 1338 is also coupled to counter timer ports 1346 and watchdog timer ports 1348. In some implementations of the helium-3 manufacturing control computer 1300, the second bridge 1316 is operably coupled to an expansion bus 1350.

In some implementations, the Ethernet® controller 1318 is operably coupled to magnetics 1352 which is operably coupled to an Ethernet® local area network 1354

With proper digital amplifiers and analog signal conditioners, the helium-3 manufacturing control computer 1300 can be programmed to drive the particle accelerator 110 in FIG. 1, FIG. 3-5 and FIG. 7, either in a predetermined sequence, or interactively modify control of the particle accelerator 110 in response to sensors in the particle accelerator 110 and output of helium-3 and other by-products. The particle accelerator 110 can be monitored by thermal sensors, the output of which, after passing through appropriate signal conditioners, can be read by the analog to digital converters that are part of the data acquisition circuit 1338. Thus the data from the particle accelerator 110 can be made available as information that the application program can operate on in as part of its decision-making software that acts to control the particle accelerator 110 in order to reduce danger and improve output of helium-3.

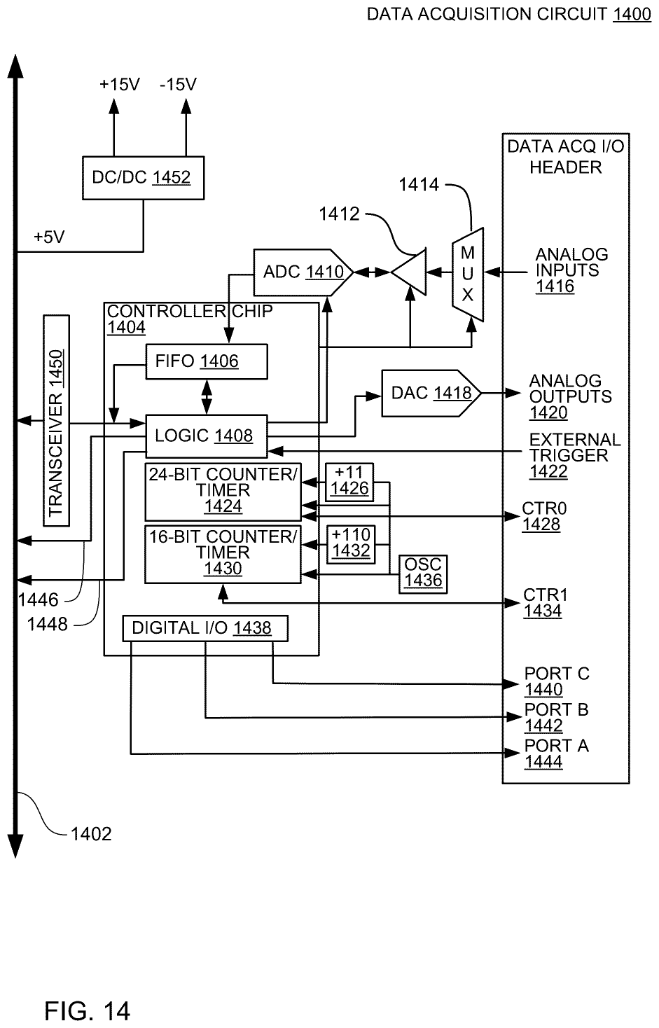

FIG. 14 is a block diagram of a data acquisition circuit 1400 of a helium-3 manufacturing control computer, according to an implementation. The data acquisition circuit 1400 is one example of the data acquisition circuit 1338 in FIG. 13 above. Some implementations of the data acquisition circuit 1400 provide 16-bit A/D performance with input voltage capability up to +/−10V, and programmable input ranges.

The data acquisition circuit 1400 can include a bus 1402, such as a conventional PC/104 bus. The data acquisition circuit 1400 can be operably coupled to a controller chip 1404. Some implementations of the controller chip 1404 include an analog/digital first-in/first-out (FIFO) buffer 1406 that is operably coupled to controller logic 1408. In some implementations of the data acquisition circuit 1400, the FIFO 1406 receives signal data from and analog/digital converter (ADC) 1410, which exchanges signal data with a programmable gain amplifier 1412, which receives data from a multiplexer 1414, which receives a signal data from analog inputs 1416.

In some implementations of the data acquisition circuit 1400, the controller logic 1408 sends signal data to the ADC 1410 and a digital/analog converter (DAC) 1418. The DAC 1418 sends signal data to analog outputs. The analog outputs, after proper amplification, can be used to manage the particle accelerator 110. In some implementations of the data acquisition circuit 1400, the controller logic 1408 receives signal data from an external trigger 1422.

In some implementations of the data acquisition circuit 1400, the controller chip 1404 includes a digital input/output (I/O) component 1438 that sends digital signal data to computer output ports.

In some implementations of the data acquisition circuit 1400, the controller logic 1408 sends signal data to the bus 1402 via a control line 1446 and an interrupt line 1448. In some implementations of the data acquisition circuit 1400, the controller logic 1408 exchanges signal data to the bus 1402 via a transceiver 1450.

Some implementations of the data acquisition circuit 1400 include 12-bit D/A channels, programmable digital I/O lines, and programmable counter/timers. Analog circuitry can be placed away from the high-speed digital logic to ensure low-noise performance for important applications. Some implementations of the data acquisition circuit 1400 are fully supported by operating systems that can include, but are not limited to, DOS™, Linux™, RTLinux™, QNX™, Windows 98/NT/2000/XP/CE™, Forth™, and VxWorks™ to simplify application development.

FIG. 15 is a block diagram of a hardware and operating environment 1500 in which different implementations can be practiced. The description of FIG. 15 provides an overview of computer hardware and a suitable computing environment in conjunction with which some implementations can be implemented. Implementations are described in terms of a computer executing computer-executable instructions. However, some implementations can be implemented entirely in computer hardware in which the computer-executable instructions are implemented in read-only memory. Some implementations can also be implemented in client/server computing environments where remote devices that perform tasks are linked through a communications network. Program modules can be located in both local and remote memory storage devices in a distributed computing environment.

Computer 1502 includes a processing unit 1504, commercially available from Intel, Motorola, Cyrix and others. The computer 1502 is one implementation of the controller in FIG. 1, FIG. 3-5 and FIG. 7. The computer 1502 also includes system memory 1506 that includes random-access memory RAM 1508 and read-only memory ROM 1510. The computer 1502 also includes one or more mass storage devices 1512; and a system bus 1514 that operatively couples various system components to the processing unit 1504. The RAM 1508 and ROM 1510, and mass storage devices 1512, are types of computer-accessible media. Mass storage devices 1512 are more specifically types of nonvolatile computer-accessible media and can include one or more hard disk drives, floppy disk drives, optical disk drives, and tape cartridge drives. The processing unit 1504 executes computer programs stored on the computer-accessible media.

Computer 1502 can be communicatively connected to the Internet 1516 via a communication device, such as modem 1518. Internet 1516 connectivity is well known within the art. In one implementation, the modem 1518 responds to communication drivers to connect to the Internet 1516 via what is known in the art as a “dial-up connection.” In another implementation, the communication device is an Ethernet® or network adapter 1520 connected to a local-area network (LAN) 1522 that itself is connected to the Internet 1516 via what is known in the art as a “direct connection” (e.g., T1 line, etc.).

A user enters commands and information into the computer 1502 through input devices such as a keyboard (not shown) or a pointing device (not shown). The keyboard permits entry of textual information into computer 1502, as known within the art, and implementations are not limited to any particular type of keyboard. Pointing device permits the control of the screen pointer provided by a graphical user interface (GUI) of operating systems such as versions of Microsoft Windows®. Implementations are not limited to any particular pointing device. Such pointing devices include mice, touch pads, trackballs, remote controls and point sticks. Other input devices (not shown) can include a microphone, joystick, game pad, satellite dish, scanner, or the like.

In some implementations, computer 1502 is operatively coupled to a display device 1524. Display device 1524 is connected to the system bus 1514 through a video adapter 1526. Display device 1524 permits the display of information, including computer, video and other information, for viewing by a user of the computer. Implementations are not limited to any particular display device 1524. Such display devices include cathode ray tube (CRT) displays (monitors), as well as flat panel displays such as liquid crystal displays (LCD's). In addition to a monitor, computers typically include other peripheral input/output devices such as printers (not shown). Speakers (not shown) provide audio output of signals. Speakers are also connected to the system bus 1514.

Computer 1502 can be operated using at least one operating system to provide a graphical user interface (GUI) including a user-controllable pointer. Computer 1502 can have at least one web browser application program executing within at least one operating system, to permit users of computer 1502 to access intranet or Internet world-wide-web pages as addressed by Universal Resource Locator (URL) addresses. Examples of browser application programs include Netscape Navigator® and Microsoft Internet Explorer®.

The computer 1502 can operate in a networked environment using logical connections to one or more remote computers, such as remote computer 1528. These logical connections are achieved by a communication device coupled to, or a part of, the computer 1502. Implementations are not limited to a particular type of communications device. The remote computer 1528 can be another computer, a server, a router, a network PC, a client, a peer device or other common network node. The logical connections depicted in FIG. 15 include the local-area network (LAN) 1522 and a wide-area network (WAN). Such networking environments are commonplace in offices, enterprise-wide computer networks, intranets and the Internet.

When used in a LAN-networking environment, the computer 1502 and remote computer 1528 are connected to the local network 1522 through network interfaces or adapters 1520, which is one type of communications device 1518. When used in a conventional WAN-networking environment, the computer 1502 and remote computer 1528 communicate with a WAN through modems. The modems, which can be internal or external, is connected to the system bus 1514. In a networked environment, program modules depicted relative to the computer 1502, or portions thereof, can be stored in the remote computer 1528.

Computer 1502 also includes an operating system 1530 that can be stored on the RAM 1508 and ROM 1510, and/or mass storage device 1512, and is and executed by the processing unit 1504. Examples of operating systems include Microsoft Windows®, Apple MacOS®, Linux®, UNIX®, providing capability for supporting application programs 1532 using, for example, code modules written in the C++® computer programming language. Examples are not limited to any particular operating system, however, and the construction and use of such operating systems are well known within the art.

Instructions can be stored via the mass storage devices 1512 or system memory 1506, including one or more application programs 1532, other program modules 1534 and program data 1536.

Computer 1502 also includes power supply. Each power supply can be a battery.

Some implementations include computer instructions to control the particle accelerator 110 that can be implemented in instructions or the instructions stored via the mass storage devices 1512 or system memory 1506 in FIG. 15.

FIG. 16 is a block diagram of a helium-3 manufacturing control mobile device 1600, according to an implementation. The helium-3 manufacturing control mobile device 1600 includes a number of components such as a main processor 1602 that controls the overall operation of the helium-3 manufacturing control mobile device 1600. Communication functions, including data and voice communications, are performed through a communication subsystem 1604. The communication subsystem 1604 receives messages from and sends messages to a wireless network 1606. In this exemplary implementation of the helium-3 manufacturing control mobile device 1600, the communication subsystem 1604 is configured in accordance with the Global System for Mobile Communication (GSM), General Packet Radio Services (GPRS) standards, 3G, 4G, 5G and/or 6G. It will also be understood by persons skilled in the art that the implementations described herein are intended to use any other suitable standards that are developed in the future. The wireless link connecting the communication subsystem 1604 with the wireless network 1606 represents one or more different Radio Frequency (RF) channels, operating according to defined protocols specified for 4G or 5G communications. With newer network protocols, these channels are capable of supporting both circuit switched voice communications and packet switched data communications.

Although the wireless network 1606 associated with helium-3 manufacturing control mobile device 1600 is a GSM/GPRS, 3G, 4G, 5G and/or 6G wireless network in one exemplary implementation, other wireless networks may also be associated with the helium-3 manufacturing control mobile device 1600 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks, 3G, 4G, 5G and/or 6G. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems.

The main processor 1602 also interacts with additional subsystems such as a Random Access Memory (RAM) 1608, a flash memory 1610, a display 1612, an auxiliary input/output (I/O) subsystem 1614, a data port 1616, a keyboard 1618, a speaker 1620, a microphone 1622, short-range communications 1624 and other device subsystems 1626.

Some of the subsystems of the helium-3 manufacturing control mobile device 1600 perform communication-related functions, whereas other subsystems may provide “resident” or on-device functions. By way of example, the display 1612 and the keyboard 1618 may be used for both communication-related functions, such as entering a text message for transmission over the wireless network 1606, and device-resident functions such as a calculator or task list.

The helium-3 manufacturing control mobile device 1600 can send and receive communication signals over the wireless network 1606 after required network registration or activation procedures have been completed. Network access is associated with a subscriber or user of the helium-3 manufacturing control mobile device 1600. To identify a subscriber, the helium-3 manufacturing control mobile device 1600 requires a SIM/RUIM card 1628 (i.e. Subscriber Identity Module or a Removable User Identity Module) to be inserted into a SIM/RUIM interface 1630 in order to communicate with a network. The SIM card or RUIM 1628 is one type of a conventional “smart card” that can be used to identify a subscriber of the helium-3 manufacturing control mobile device 1600 and to customize the helium-3 manufacturing control mobile device 1600, among other aspects. Without the SIM card 1628, the helium-3 manufacturing control mobile device 1600 is not fully operational for communication with the wireless network 1606. By inserting the SIM card/RUIM 1628 into the SIM/RUIM interface 1630, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 1628 includes a processor and memory for storing information. Once the SIM card/RUIM 1628 is inserted into the SIM/RUIM interface 1630, it is coupled to the main processor 1602. In order to identify the subscriber, the SIM card/RUIM 162 can include some user parameters such as an International Mobile Subscriber Identity (IMSI). An advantage of using the SIM card/RUIM 1628 is that a subscriber is not necessarily bound by any single physical mobile device. The SIM card/RUIM 1628 may store additional subscriber information for a mobile device as well, including datebook (or calendar) information and recent call information. Alternatively, user identification information can also be programmed into the flash memory 1610.

The helium-3 manufacturing control mobile device 1600 is a battery-powered device and includes a battery interface 1632 for receiving one or more rechargeable batteries 1634. In one or more implementations, the battery 1634 can be a smart battery with an embedded microprocessor. The battery interface 1632 is coupled to a regulator 1636, which assists the battery 1634 in providing power V+ to the helium-3 manufacturing control mobile device 1600. Although current technology makes use of a battery, future technologies such as micro fuel cells may provide the power to the helium-3 manufacturing control mobile device 1600.

The helium-3 manufacturing control mobile device 1600 also includes an operating system 1638 and software components 1640 to 1652 which are described in more detail below. The operating system 1638 and the software components 1640 to 1652 that are executed by the main processor 1602 are typically stored in a persistent store such as the flash memory 1610, which may alternatively be a read-only memory (ROM) or similar storage element (not shown). Those skilled in the art will appreciate that portions of the operating system 1638 and the software components 1640 to 1652, such as specific device applications, or parts thereof, may be temporarily loaded into a volatile store such as the RAM 1608. Other software components can also be included.

The subset of software components 1640 that control basic device operations, including data and voice communication applications, will normally be installed on the helium-3 manufacturing control mobile device 1600 during its manufacture. Other software applications include a message application 1642 that can be any suitable software program that allows a user of the helium-3 manufacturing control mobile device 1600 to send and receive electronic messages. Various alternatives exist for the message application 1642 as is well known to those skilled in the art. Messages that have been sent or received by the user are typically stored in the flash memory 1610 of the helium-3 manufacturing control mobile device 1600 or some other suitable storage element in the helium-3 manufacturing control mobile device 1600. In one or more implementations, some of the sent and received messages may be stored remotely from the helium-3 manufacturing control mobile device 1600 such as in a data store of an associated host system with which the helium-3 manufacturing control mobile device 1600 communicates.

The software applications can further include a device state module 1644, a Personal Information Manager (PIM) 1646, and other suitable modules (not shown). The device state module 1644 provides persistence, i.e. the device state module 1645 ensures that important device data is stored in persistent memory, such as the flash memory 1610, so that the data is not lost when the helium-3 manufacturing control mobile device 1600 is turned off or loses power.

The PIM 1646 includes functionality for organizing and managing data items of interest to the user, such as, but not limited to, e-mail, contacts, calendar events, voice mails, appointments, and task items. A PIM application has the ability to send and receive data items via the wireless network 1606. PIM data items may be seamlessly integrated, synchronized, and updated via the wireless network 1606 with the mobile device subscriber's corresponding data items stored and/or associated with a host computer system. This functionality creates a mirrored host computer on the helium-3 manufacturing control mobile device 1600 with respect to such items. This can be particularly advantageous when the host computer system is the mobile device subscriber's office computer system.

The helium-3 manufacturing control mobile device 1600 also includes a connect module 1648, and an IT policy module 1650. The connect module 1648 implements the communication protocols that are required for the helium-3 manufacturing control mobile device 1600 to communicate with the wireless infrastructure and any host system, such as an enterprise system, with which the helium-3 manufacturing control mobile device 1600 is authorized to interface.

The connect module 1648 includes a set of APIs that can be integrated with the helium-3 manufacturing control mobile device 1600 to allow the helium-3 manufacturing control mobile device 1600 to use any number of services associated with the enterprise system. The connect module 1648 allows the helium-3 manufacturing control mobile device 1600 to establish an end-to-end secure, authenticated communication pipe with the host system. A subset of applications for which access is provided by the connect module 1648 can be used to pass IT policy commands from the host system to the helium-3 manufacturing control mobile device 1600. This can be done in a wireless or wired manner. These instructions can then be passed to the IT policy module 1650 to modify the configuration of the helium-3 manufacturing control mobile device 1600. Alternatively, in some cases, the IT policy update can also be done over a wired connection.

The IT policy module 1650 receives IT policy data that encodes the IT policy. The IT policy module 1650 then ensures that the IT policy data is authenticated by the helium-3 manufacturing control mobile device 1600. The IT policy data can then be stored in the flash memory 1610 in its native form. After the IT policy data is stored, a global notification can be sent by the IT policy module 1650 to all of the applications residing on the helium-3 manufacturing control mobile device 1600. Applications for which the IT policy may be applicable then respond by reading the IT policy data to look for IT policy rules that are applicable.

The IT policy module 1650 can include a parser 1652, which can be used by the applications to read the IT policy rules. In some cases, another module or application can provide the parser. Grouped IT policy rules, described in more detail below, are retrieved as byte streams, which are then sent (recursively) into the parser to determine the values of each IT policy rule defined within the grouped IT policy rule. In one or more implementations, the IT policy module 1650 can determine which applications are affected by the IT policy data and send a notification to only those applications. In either of these cases, for applications that are not being executed by the main processor 1602 at the time of the notification, the applications can call the parser or the IT policy module 1650 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 1650 sends an acknowledgement back to the host system to indicate that the IT policy data was received and successfully applied.

Other types of software applications can also be installed on the helium-3 manufacturing control mobile device 1600. These software applications can be third party applications, which are added after the manufacture of the helium-3 manufacturing control mobile device 1600. Examples of third party applications include games, calculators, utilities, etc.

The additional applications can be loaded onto the helium-3 manufacturing control mobile device 1600 through at least one of the wireless network 1606, the auxiliary I/O subsystem 1614, the data port 1616, the short-range communications subsystem 1624, or any other suitable device subsystem 1624. This flexibility in application installation increases the functionality of the helium-3 manufacturing control mobile device 1600 and may provide enhanced on-device functions, communication-related functions, or both. For example, secure communication applications may enable electronic commerce functions and other such financial transactions to be performed using the helium-3 manufacturing control mobile device 1600.

The data port 1616 enables a subscriber to set preferences through an external device or software application and extends the capabilities of the helium-3 manufacturing control mobile device 1600 by providing for information or software downloads to the helium-3 manufacturing control mobile device 1600 other than through a wireless communication network. The alternate download path may, for example, be used to load an encryption key onto the helium-3 manufacturing control mobile device 1600 through a direct and thus reliable and trusted connection to provide secure device communication.

The data port 1616 can be any suitable port that enables data communication between the helium-3 manufacturing control mobile device 1600 and another computing device. The data port 1616 can be a serial or a parallel port. In some instances, the data port 1616 can be a USB port that includes data lines for data transfer and a supply line that can provide a charging current to charge the battery 1634 of the helium-3 manufacturing control mobile device 1600.

The short-range communications subsystem 1624 provides for communication between the helium-3 manufacturing control mobile device 1600 and different systems or devices, without the use of the wireless network 1606. For example, the subsystem 1624 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 1604 and input to the main processor 1602. The main processor 1602 will then process the received signal for output to the display 1612 or alternatively to the auxiliary I/O subsystem 1614. A subscriber may also compose data items, such as e-mail messages, for example, using the keyboard 1618 in conjunction with the display 1612 and possibly the auxiliary I/O subsystem 1614. The auxiliary subsystem 1614 may include devices such as: a touch screen, mouse, track ball, infrared fingerprint detector, or a roller wheel with dynamic button pressing capability. The keyboard 1618 is preferably an alphanumeric keyboard and/or telephone-type keypad. However, other types of keyboards may also be used. A composed item may be transmitted over the wireless network 1606 through the communication subsystem 1604.

For voice communications, the overall operation of the helium-3 manufacturing control mobile device 1600 is substantially similar, except that the received signals are output to the speaker 1620, and signals for transmission are generated by the microphone 1622. Alternative voice or audio I/O subsystems, such as a voice message recording subsystem, can also be implemented on the helium-3 manufacturing control mobile device 1600. Although voice or audio signal output is accomplished primarily through the speaker 1620, the display 1612 can also be used to provide additional information such as the identity of a calling party, duration of a voice call, or other voice call related information.

In some implementations, the helium-3 manufacturing control mobile device 1600 includes a camera 1654 receiving a plurality of images 1656 from and examining pixel-values of the plurality of images 1656.

### CONCLUSION

A helium-3 manufacturing system is described. A technical effect of the helium-3 manufacturing system is productive output of helium-3 with fewer harmful or dangerous by-products. Although specific implementations are illustrated and described herein, it will be appreciated by those of ordinary skill in the art that any arrangement which is calculated to achieve the same purpose may be substituted for the specific implementations shown. This application is intended to cover any adaptations or variations. One of ordinary skill in the art will appreciate that implementations can be made in other ways that provide the required function.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to improved power sources, future particle accelerators, different particle guns and new beam transport systems.

The terminology used in this application meant to include all particle accelerators and alternate technologies which provide the same functionality as described herein.

1. A system for manufacturing helium-3 gas, the system comprising:
a target; and
a particle accelerator that forms a beam of protons that is directed at the target, causing a collision between the beam of the protons and the target, the collision producing the helium-3 gas, the particle accelerator including a power source that is operably coupled to a proton gun that is operably coupled to a beam transport system.

2. The system of claim 1 wherein the beam transport system further comprises:
a waveguide that is operably coupled to steering coils that are operably coupled to focusing coils.

3. The system of claim 1 further comprising:
the target includes high pressure gas.

4. The system of claim 1 further comprising:
the target is chemically combined with a substance forming a stable hydride, such as titanium, that will not react with the beam of the protons.

5. The system of claim 1 wherein the particle accelerator further comprises:
a controller operably coupled to the particle accelerator and operable to control the particle accelerator.

6. The system of claim 1 further comprising:
a controller that is external to the particle accelerator.

7. The system of claim 6 wherein the controller further comprises:
a helium-3 manufacturing control computer.

8. The system of claim 6 wherein the controller further comprises:
a hardware and operating environment.

9. The system of claim 6 wherein the controller further comprises:
a helium-3 manufacturing control mobile device.

10. A method for manufacturing helium-3 comprising:
forming a beam of protons that is directed at a target, the forming performed by a particle accelerator, causing a collision between the beam of the protons and the target, the collision producing helium-3 gas, the particle accelerator including a power source that is operably coupled to a proton gun that is operably coupled to a beam transport system; and
gathering the helium-3 gas.

11. The method of claim 10 wherein the beam transport system further comprises:
a waveguide that is operably coupled to steering coils that are operably coupled to focusing coils.

12. The method of claim 10 further comprising:
the target includes high pressure gas.

13. The method of claim 10 further comprising:
the target is chemically combined with a substance forming a stable hydride, such as titanium, that will not react with the beam of the protons.

14. The method of claim 10 wherein the particle accelerator further comprises:
a controller operably coupled to and operable to control the particle accelerator.

15. The method of claim 10 further comprising:
a controller that is external to the particle accelerator.

16. The method of claim 15 wherein the controller further comprises: a helium-3 manufacturing control computer.

17. The method of claim 15 wherein the controller further comprises:
a hardware and operating environment.

18. The method of claim 15 wherein the controller further comprises
a helium-3 manufacturing control mobile device.

19-100. (canceled)
